(19) United States
(12) Patent Application Publication
(10) Pub. No.: US 2016/0251173 A1
(43) Pub. Date: Sep. 1, 2016

(54) APPARATUS FOR ACTING ON MATERIAL TO BE CONVEYED IN A MATERIAL CONVEYING SYSTEM

(71) Applicant: MARICAP OY, Vantaa (FI)

(72) Inventor: Göran SUNDHOLM, Tuusula (FI)

(73) Assignee: MARICAP OY, Vantaa (FI)

(21) Appl. No.: 14/904,478

(22) PCT Filed: Jul. 29, 2014
(86) PCT No.: PCT/FI2014/050598

§ 371 Date: Jan. 12, 2016

(30) Foreign Application Priority Data
Jul. 30, 2013 (FI) 20135801
Dec. 4, 2013 (FI) 20136222

(51) Int. Cl. B65G 53/58; B65G 53/24

(52) U.S. Cl. CPC B65G 53/58; B65G 53/24; B65G 2205/04

(57) ABSTRACT

Apparatus for acting on material to be conveyed in a material conveying channel, which apparatus comprises an impeding means (30), which can be arranged in the material conveying channel, which impeding means (30) can be moved between at least two positions, a first position, in which the impeding means (30) extends into the channel space (10) of the material conveying channel, and a second position, in which the impeding means does not essentially extend into the channel space of the material conveying channel. Means (31, 33) are arranged in connection with the impeding means (30), for conducting flowing medium, such as replacement air, from outside the material conveying channel into the channel space (10) of the material conveying channel to the point of, or into the vicinity of, the impeding means (30).

### FIELD OF THE INVENTION

The object of the invention is an apparatus as defined in the preamble of claim 1.

The invention also relates to a system according to claim 18.

### BACKGROUND OF THE INVENTION

The invention relates generally to material conveying systems, such as to pneumatic partial-vacuum transporting systems, more particularly to the collection and conveying of wastes, such as to the conveying of household wastes. Such systems are presented in publications WO 2009/080880, WO 2009/080881, WO 2009/080882, WO 2009/080883, WO 2009/080884, WO 2009/080885, WO 2009/080886, WO 2009/080887 and WO 2009/080888, among others. The invention also relates to waste feeding means, such as to input points or refuse chutes, with which waste is conveyed, typically by gravity, e.g. from higher input apertures in residential buildings to a lower collection space or corresponding container.

Systems wherein wastes are conveyed in piping by means of a pressure difference or suction are known in the art. In these, wastes are conveyed long distances in the piping by sucking. It is typical to these systems that a partial-vacuum apparatus is used to achieve a pressure difference, in which apparatus negative pressure is brought about in the conveying pipe with partial-vacuum generators, such as with a fan, with vacuum pumps or with an ejector apparatus. A conveying pipe typically comprises at least one valve means, by opening and closing which the replacement air coming into the conveying pipe is regulated. Waste input points, e.g. rubbish containers or refuse chutes, are used in the systems at the waste material input end, into which waste input points material, such as waste material, is fed and from which waste input points the material to be conveyed is conveyed into a conveying pipe by opening a discharge valve means, in which case, by means of the sucking effect achieved by the aid of the partial vacuum acting in the conveying pipe and also by means of the surrounding air pressure acting via the refuse chute, material such as e.g. waste material packed into bags, is conveyed from the refuse chute into the conveying pipe and onwards to a reception point, where the material to be transported is separated from the transporting air and conveyed for further processing or e.g. into a shipping container. The pneumatic waste conveying systems in question can be utilized particularly well in densely populated urban areas. These types of areas have tall buildings, in which the input of wastes into a pneumatic conveying system for wastes is performed via an input point, such as a refuse chute arranged, in the building.

Material can be conducted from an input point along a refuse chute into a container that is lower in the vertical direction, or an intermediate container can be in connection with the input points, into which intermediate container material fed from an input point is initially conducted and from where the waste material is conveyed onwards along the conveying piping to a reception point.

Apparatuses that comprise an impeding means are used in connection with material conveying systems, with which impeding means the material being conveyed in the material conveying channel can be acted upon and the feeding onward of material in the material conveying channel can be regulated. The impeding means in the apparatuses can typically be such that they can be moved with a drive device into the channel space of the material conveying channel and out of the channel space of the material conveying channel. One such is presented in, among others, publication JP 54079780U. One drawback, among others, of prior art is that the material being conveyed can block the entry of flowing medium, more particularly the entry of replacement air, into the vicinity of the impeding means. This can e.g. hinder material starting to move when the impeding means leaves the channel space of the material conveying channel in pneumatic pipe transport systems for material.

The aim of the present invention is to achieve an entirely new type of solution, by means of which the drawbacks of prior art solutions are avoided.

### BRIEF DESCRIPTION OF THE INVENTION

The invention is based on a concept in which means are arranged in connection with the impeding means, for bringing flowing medium, such as replacement air, into the channel space of the material conveying channel.

The apparatus according to the invention is mainly characterized by what is stated in claim 1.

The apparatus according to the invention is additionally characterized by what is stated in claims 2-17.

The system according to the invention is characterized by what is stated in claim 18.

The solution according to the invention has a number of important advantages. The impeding means can be a means arranged in the material conveying channel, through which means, or around the sides of which means, an air flow is able to travel. The impeding means acts on the material by bringing about a support effect in it, which mainly prevents, to at least a significant extent, the passage of the material past or through the impediment. According to one embodiment the impediment is a force-receiving means arranged in the material conveying channel, which means can be placed into the channel and displaced out of it with a drive device. According to one embodiment of the invention means for bringing flowing medium, such as replacement air, into the vicinity of the impediment can be arranged in connection with the impediment, at least when material is conveyed in the conveying piping after the removal of the impediment. In this case flowing medium, such as replacement air, can be brought into the bulk of material being conveyed, which boosts the conveying efficiency of material in the conveying pipe. With the solution according to the invention an intermediate container of the desired size can be achieved, the material being fed into which container can be compressed by means of one or more impediments and an air flow. The apparatus according to the invention can be applied e.g. in pneumatic material conveying systems, such as in pneumatic pipe transport systems for wastes. By the aid of the impeding means, e.g. the compacting of the material being conveyed against the impediment can be achieved. In this case, by the aid of the impeding means, e.g. more efficient use of intermediate container capacity can be achieved as the material conveying channel functions as an intermediate container. According to a second embodiment the impeding means can be used as an arrester means e.g. in a waste chute before a shaper of the material, such as a rotary shaper or grinder. In this case e.g. excessive loading on the handling means of the material shaper, or on the drive means of them, caused by the material can be avoided. By means of the invention flowing medium, such as a gas, more particularly replacement air, can be effectively brought into the vicinity of, or to the point of, an impeding means in the material conveying channel. Situating the parts or apertures of the impeding means on the side that is away from the input direction enables the passage of flowing medium, even if material intended for conveying was against the impeding means on the input side. By forming the impeding means to be tubular, an effective structure for an impeding means is achieved. Providing the wall of a tubular impeding means with an aperture enables an effective method to conduct flowing medium, more particularly replacement air, into the channel space of the material conveying channel to the point of, or into the vicinity of, the impeding means. By forming the impeding means from bar parts, rod parts or profile parts, a second effective embodiment for the structure of an impeding means is achieved. Arranging guide surfaces or guide parts in the apparatus and a detent surface for the impeding means achieves effective retention of the impeding means in the desired direction in relation to the channel space of the material conveying channel.

### BRIEF DESCRIPTION OF THE FIGURES

In the following, the invention will be described in more detail by the aid of an embodiment with reference to the attached drawings, wherein

FIGS. 1a-1c present one embodiment of the apparatus according to the invention in a first operating state, the impeding means being in the first position, FIG. 1a from the direction of the arrow B of FIG. 1b, FIG. 1b a partial cross-section along the line Ib-Ib of FIG. 1a, and FIG. 1c as viewed obliquely in perspective,

FIGS. 2a-2c present one embodiment of the apparatus according to the invention in a second operating state, FIG. 2a from the direction of the arrow B of FIG. 2b, FIG. 2b a partial cross-section along the line IIb-IIb of FIG. 2a, and FIG. 2c as viewed obliquely in perspective,

FIGS. 3a-3c present one apparatus of an embodiment of the invention in a third operating state, the impeding means being in the second position, FIG. 3a from the direction of the arrow B of FIG. 3b, FIG. 3b a partial cross-section along the line IIIb-IIIb of FIG. 3a, and FIG. 3c as viewed obliquely in perspective,

FIGS. 4a-4d present an apparatus according to one embodiment of the invention partially cross-sectioned, in FIG. 4a cross-sectioned along the line IVa-IVa of FIG. 4b, the impeding means being in the first position, in FIG. 4b cross-sectioned along the line IVb-IVb of FIG. 4a, the impeding means being in the second position, in FIG. 4c cross-sectioned along the line IVc-IVc of FIG. 4b, and in FIG. 4d a detail from FIG. 4b, the impeding means being in the first position.

### DETAILED DESCRIPTION OF THE INVENTION

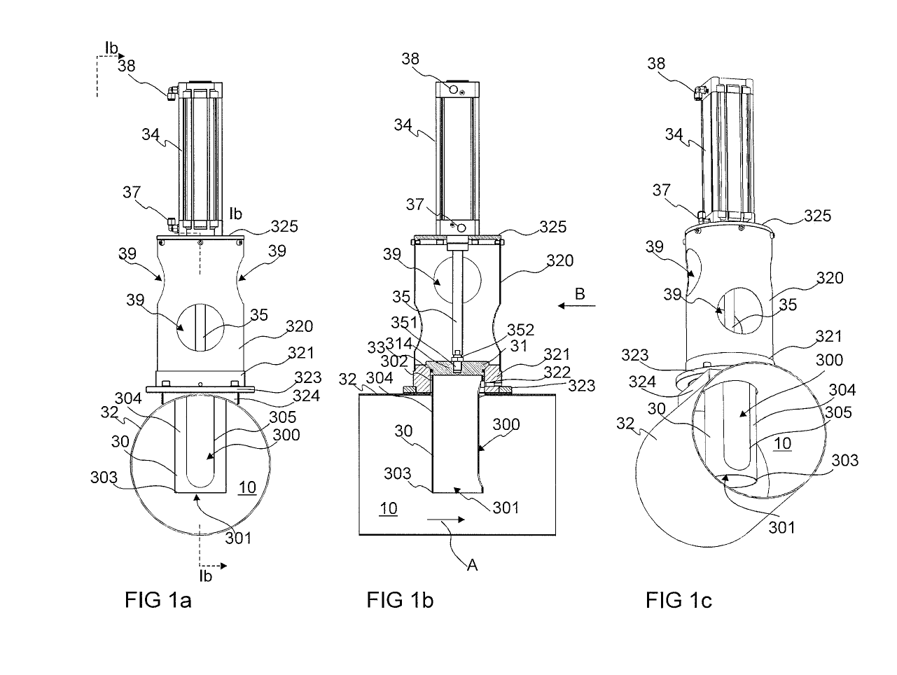

FIGS. 1a-1c, 2a-2c and 3a-3c present an apparatus according to one embodiment of the invention. The apparatus is adapted to act on material to be conveyed in a material conveying channel. The apparatus comprises an impeding means 30, which can be arranged in the material conveying channel. The impeding means 30 can be moved between at least two positions, a first position, in which the impeding means 30 extends into the channel space 10 of the material conveying channel, and a second position, in which the impeding means does not essentially extend into the channel space of the material conveying channel. Drive means 34, 35 are arranged to move the impeding means. In the embodiment of the figures the impeding means 30 is a member extending into the material conveying channel, into the channel space 10 of the channel section, which member is adapted to receive at least a part of the force effect of the material conducted in the material conveying channel, in the channel space 10 of it, when the material is conveyed in the material conveying channel, e.g. by means of gravity or a pressure difference or suction and a replacement air flow, or a combination of these, against the impeding means 30.

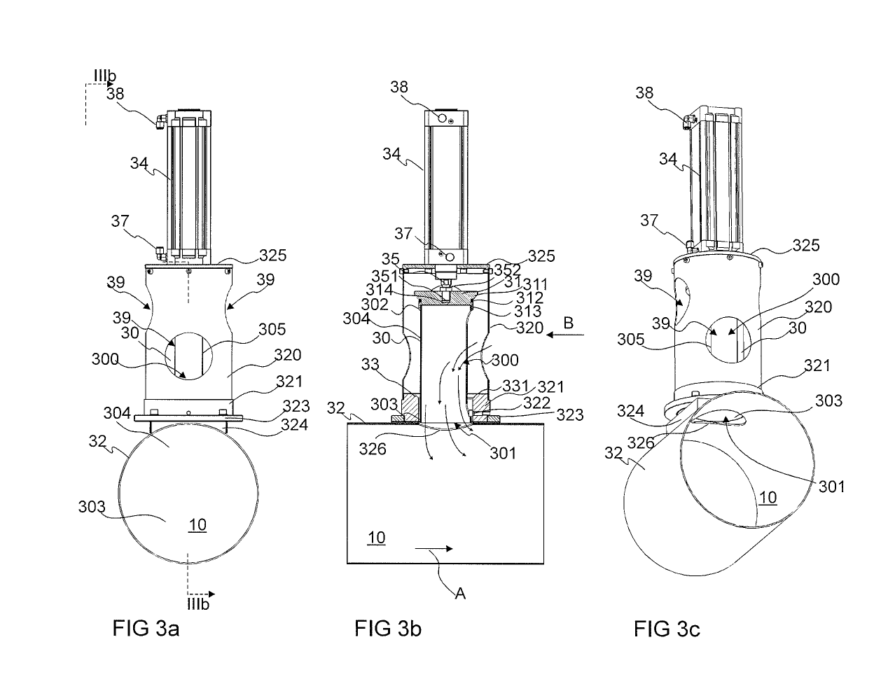

The apparatus of the invention in the embodiment of FIGS. 1a-3c comprises a fixing frame, which is arranged onto the channel section 32. The fixing frame in the embodiment of FIGS. 1a-3c comprises a cylindrical section 320. A frame part 34 of the drive device is arranged onto the first end part 325 of the cylindrical section. An end part 321 is arranged on the end of the fixing frame, on the channel section 32 side. An aperture 33 is formed in the end part 321, which aperture extends from the first side of the end part 321 to the second side and onwards through the wall of the channel part 32 into the channel space 10. In FIGS. 3b, 3c the edge 326 of the aperture 33 in the wall of the channel part 32 can also be seen. In the embodiment of FIGS. 1a-1c, the fixing frame is arranged onto the channel section 32 with an adapter part 324. The end part 321 is fixed from the flange section 323 to the adapter section 324 with fixing means, e.g. with screws. The frame part 34 of the drive device is the cylinder part of a cylinder piston unit, which cylinder part is arranged with fixing means on the end part 325 of the fixing frame that is away from the channel part 32.

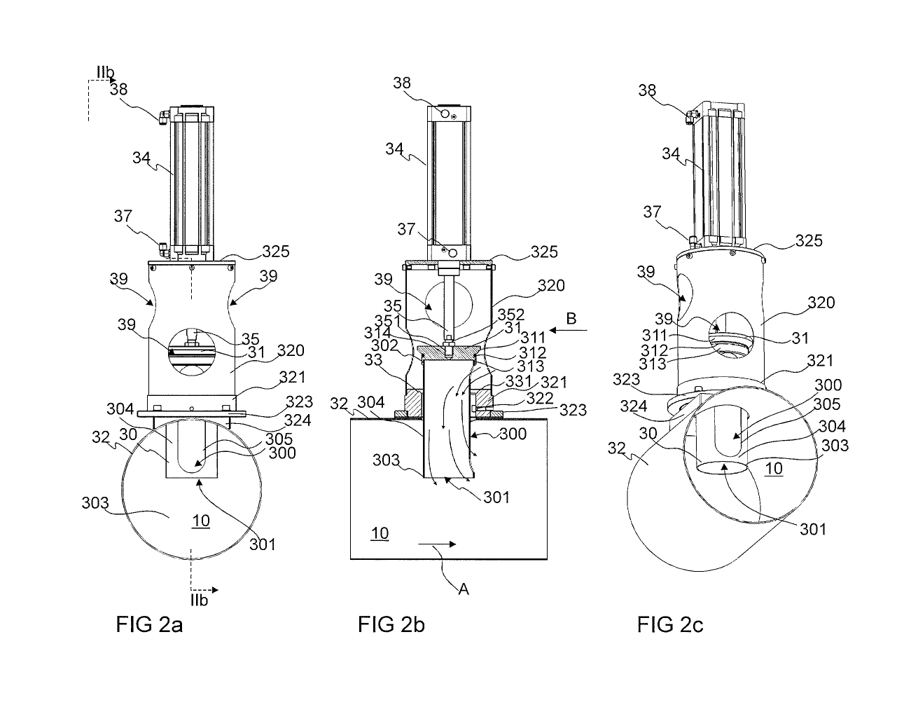

The drive device comprises a stem part, such as the piston rod 35 of a cylinder/piston unit, on the end of which piston rod that is away from the piston an impeding means 30 is arranged. The impeding means 30 is then arranged on a moving part of the drive device, which moving part is in the figures a piston rod 35, which is attached to the piston part, which is in turn arranged in a manner that allows it to be moved into the cylinder space of the cylinder part 34. In the cylinder part the piston is moved by conducting pressure medium into the cylinder space in the manner desired, that is per se known in the art, to different sides of the piston via the conveying channels 37, 38 for the medium. FIGS. 1a-3c do not present the conveying pipe for the medium, but instead only the points of connection of the conveying channels 37, 38 formed in the cylinder part 34. The piston rod 35 is fixed to the impeding means 30 in FIG. 2b in a drilling 314 formed in the impeding means, in which drilling threads are formed, into which threads the counterthreads of the coupling part 351 of the rod 35 of the piston fit. A tightening means 352, such as a nut means, is arranged to ensure the fixing between the impeding means 30 and the piston rod 35.

FIGS. 1a-1c present a situation in which the impeding means 30 is in the first position, i.e. it extends into the channel space 10 of the channel part. In FIGS. 2a-2c the impeding means is in a situation between the first position and the second position, i.e. in an intermediate position. In FIGS. 3a-3c the impeding means is in the second position, in which the impeding means 30 does not essentially extend into the channel space 10.

Means 31, 33 are arranged in connection with the impeding means 30, for conducting flowing medium, such as replacement air, from outside the material conveying channel into the channel space 10 of the material conveying channel to the point of, or into the vicinity of, the impeding means 30.

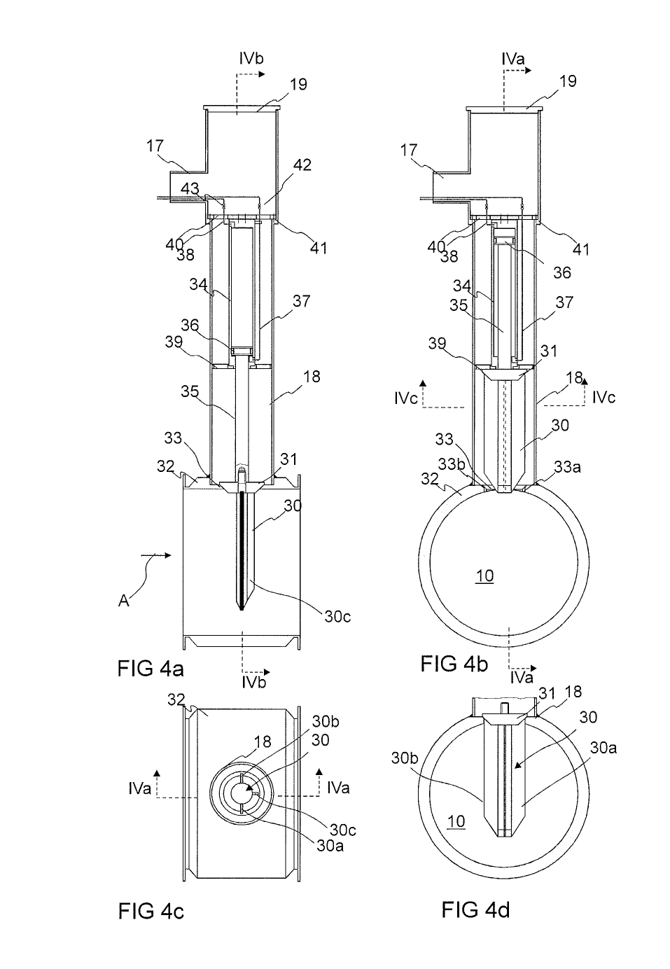

At least one aperture 39 is formed in the fixing frame for conducting flowing medium, such as replacement air, from outside the fixing frame to inside it, into the space bounded by the walls 320, 321, 325. In the embodiments of FIGS. 1a-3c, a number of apertures 39 have been formed in the side wall 320 of the fixing frame. In the embodiment of FIGS. 4a-4d replacement air is conducted to the impeding means along a medium pathway 39, 40. Replacement air can be bought into the channel space to the impeding means or to the medium pathway along a separate replacement air duct, when the impeding means 30 is in the second position or at least when a pathway has opened between the shut-off means 31 of the valve and the aperture 33. The installation depth 18 of the impeding means 30 can form a part of the pathway of the medium, the walls of which installation depth can, according to the embodiment of FIGS. 4a-4c, restrict the pathway of replacement air via the aperture 33 into the channel space 10.

A valve means 31 is arranged in connection with the impeding means 30, which valve means when opened allows the conducting of flowing medium into the channel space 10 of the material conveying channel from the point of, or from the vicinity of, the impeding means 30, and when closed prevents the conducting of flowing medium into the channel space 10. An aperture 33 has been formed in the channel section 32 (and possibly in the fixing frame), from which aperture the impeding means 30 can be arranged into the channel space 10 of the channel section and out of it.

In the embodiments of FIGS. 1a-3c and 4a-4d, the apparatus comprises a valve means 31, which is a shut-off means, which is arranged to open and close a connection from outside the material channel 32 into the material channel, into the channel space 10 of it. According to one embodiment the valve means 31 is adapted to open when displacing the impeding means 30 from the first position into the second position. The valve means 31 opens and closes, via the aperture 33, a connection for the medium, such as for replacement air, to get into the channel space 10 of the channel part.

According to one embodiment the valve means 31 is arranged to be a part of the impeding means 30 or of its moving device 34, 35. In FIGS. 1a-3c, the valve means 31 is arranged on the end of the impeding means 30 on the side of the moving device 34, 35. The end part of the impeding means is formed into a valve means 31. According to one embodiment the valve means 31 has a sealing surface 311, and a countersurface 331 for the sealing surface is arranged on the wall of the aperture 33 through which the impeding means is displaced into the channel space 10 and out of it. In the embodiment of the figure, the sealing surface 311 is a surface having the shape of a truncated cone. The impeding means 30 extends away from the valve means 31 towards the channel space of the channel part. The tubular section of the impeding means according to FIGS. 1a-3c is arranged at its first end 302 on the valve means, on the bottom part of it. A cylindrical section 313 is formed in the valve means 31 as an extension of the sealing surface 311 that in the figure is the shape of a downward tapering truncated cone. In FIGS. 1b, 2b, 3b a seal means 312, such as a ring seal, e.g. an O-ring, is arranged at the point of non-continuity between the sealing surface 311 and the cylindrical section 313. The cylindrical surface can form a shoulder, on the inside of which the top part of the tubular section is fitted.

According to one embodiment the impeding means 30 is adapted to cover only a part of the flow cross-sectional area of the channel space 10 of the material conveying channel. Typically the impeding means can prevent the displacement of at least some of the material to be conveyed in the channel space past the impeding means 30 in the channel space, when the impeding means extends into the channel space 10. The impeding means 30 is adapted to let a medium flow, such as a replacement air flow, past or through in the channel space 10 of the material channel.

According to one embodiment the impeding means 30 is formed from bar parts, rod parts or profile parts. FIGS. 4a-4d present an embodiment in which the impeding means is formed from bar parts, rod parts or profile parts. The impeding means comprises parts 30a, 30b in the transverse direction of the channel 10, which parts extend in the transverse direction of the channel in the orthogonal cross-section. In addition, the impeding means 30 comprises a part 30c extending away from the input side of the channel space 10 in the flow direction (arrow A in FIG. 4a) of the material.

The impeding means 30 according to the embodiment of FIGS. 1a-3c is formed to be tubular. According to one embodiment the impeding means 30 comprises at least one aperture 300, 301 for conducting flowing medium into the channel space 10 of the material conveying channel. An aperture 300 is formed in the wall 304 of the impeding means 30 according to the embodiment of FIGS. 1a-3c, for conducting flowing medium into the channel space 10 of the material conveying channel. The flowing medium is able to flow, when the impeding means is displaced towards the second position from the first position, via the apertures 39, and onwards into the channel space from between the valve means 31 and the detent surface 331 of the aperture 33. The flowing medium is able to flow either directly from between the aperture 33 and the impeding means or via one or more apertures 300, 301 formed in the impeding means into the channel space 10 of the channel part 32. FIGS. 2b and 3b present with an arrow the medium flow from outside the channel part into the channel space 10. According to FIG. 2b, the medium flow into the channel travels both via the aperture 300, which is formed in the wall 304 of the impeding means, and via the aperture 301 arranged in the free end of the impeding means.

According to the embodiment of FIGS. 1a-3c, in the free end 303 of the impeding means 30 is an aperture 301. When the impeding means has been displaced into the second position, the flowing medium is conducted into the channel space 10 mainly via the aperture 301 that is in the free end 303 of the impeding means 30.

According to one embodiment at least one guide means 33a, 33b, 322 is arranged in the apparatus and at least one detent surface 30a, 30b, 305 is arranged on the impeding means 30 for keeping the impeding means 30 in the desired direction. The guide means can be a notch or protrusion formed in the aperture suiting the detent surface of the impeding means. The guide means can be a screw or corresponding, to which the edge 305 of the aperture 300 of the guide means corresponds.

According to one embodiment the valve means 31 is adapted to open when displacing the impeding means 30 from the first position into the second position. In the embodiments of FIGS. 1a-3c and 4a-4d, the valve means 31 opens the entry of the pathway for the flowing medium into the channel space 10, when the impeding means is displaced from the first position towards the second position. Correspondingly, the valve means closes the pathway for the flowing medium into the channel space via the aperture 33, when the impeding means is displaced into the first position from the second position.

According to one embodiment the valve means 31 is arranged to be a part of the impeding means 30 or of its moving device 34, 35.

According to one embodiment the valve means 31 has a sealing surface 311. A countersurface 331 for the sealing surface is arranged on the wall of the aperture 33 through which the impeding means is displaced into the channel space 10 and out of it.

According to one embodiment at least one aperture 300 formed in the impeding means 30, in the wall 304 of it, is arranged to open to the side of the channel space 10 that is away from the input direction of the material. The input direction of the material in the channel space 10 is described in FIGS. 1b, 2b, 3b, 4a with the arrow A.

In the embodiment of the figures the impeding means 30 is a member extending into the material conveying channel, into the channel space 10 of the channel section, which member is adapted to receive at least a part of the force effect of the material conducted in the material conveying channel, in the channel space 10 of it, when the material is conveyed in the material conveying channel, e.g. by means of gravity or a pressure difference or suction and a replacement air flow, or a combination of these, against the impeding means 30. Typically the impeding means can prevent the displacement of at least some of the material past the impeding means in the channel space, when the impeding means extends into the channel space 10. The impeding means 30 is adapted to let a medium flow, such as a replacement air flow, past or through in the channel space 10 of the material channel.

One embodiment of the impeding means is described in more detail in FIGS. 4a-4d. The impeding means 30 is arranged to be movable by the aid of a drive device, which in the embodiment of the figures is a cylinder-piston combination 34, 35, 36. The impeding means assembly, with which it is arranged to be fixed to the channel section of the material conveying channel, comprises a channel part 32, which is adapted to be fixed to the channel section e.g. with a flanged joint or with some other applicable joint arrangement. An aperture 33 has been formed in the channel section 32, from which aperture the impeding means 30 can be arranged into the channel space of the channel section and out of it. In the embodiment of the figure the impeding means 30 is fixed to a moving part of the drive device, which in the figure is the rod 35 of a piston, the piston rod is attached to the piston part 36, which is movably arranged into the cylinder space of the cylinder part 34. The piston is moved by conducting pressure medium into the cylinder space in the manner desired, that is per se known in the art, to different sides of the piston via the conveying channels 37, 38 for the medium.

The device comprises a valve means, the shut-off part 31 of which is adapted to close the aperture 33 into the channel space when the impeding means 30 is in the first position, i.e. in the channel space, preventing the displacement of material in the channel part of the intermediate container. According to the embodiment of FIGS. 4a-4d, the shut-off means is arranged between the impeding means 30 and the piston rod 35. A medium pathway 39, 40 is arranged in the impeding means assembly for conducting replacement air from the replacement air duct 17, 191 into the channel space, when the impeding means 30 is in the second position or at least when a pathway has opened between the shut-off means 31 of the valve and the aperture 33.

The installation depth 18 of the impeding means can form a part of the pathway of the medium, the walls of which installation depth can, according to the embodiment of FIGS. 4a-4c, restrict the pathway of replacement air via the aperture 33 into the channel of the intermediate container.

According to FIG. 4 the impeding means assembly can be arranged in the installation depth 18 as an entity, which comprises an impeding means 30, a shut-off part 31 of the valve, a cylinder-piston combination 34, 35, 36 and conveying channel parts 38, 39 for the medium, which channel parts can be arranged with snap-on fasteners 42, 43 to the conveying channels coming from the medium source.

By arranging the input aperture 33 of the replacement air duct in the channel space in the vicinity of the impeding means, the displacement of material can be boosted from the point of the impeding means onwards in the material conveying channel, e.g. towards the material delivery end, when the impeding means is arranged into the second position out of the channel space and possible suction is switched on to act from the output direction of the material. At the same time replacement air also enters the channel space via the aperture 33.

The invention relates to an apparatus for acting on material to be conveyed in a material conveying channel, which apparatus comprises an impeding means 30, which can be arranged in the material conveying channel, which impeding means 30 can be moved between at least two positions, a first position, in which the impeding means 30 extends into the channel space 10 of the material conveying channel, and a second position, in which the impeding means does not essentially extend into the channel space of the material conveying channel. Means 31, 33 are arranged in connection with the impeding means 30, for conducting flowing medium, such as replacement air, from outside the material conveying channel into the channel space 10 of the material conveying channel to the point of, or into the vicinity of, the impeding means 30. The impeding means in the first position acts on the material in the material conveying channel by bringing about a support effect in it, which mainly prevents, to at least a significant extent, the passage of the material past or through the impediment. In one embodiment the flowing medium is a gaseous substance. In one embodiment the material is conveyed in the channel space by means of a pressure difference or suction, in which case the transporting medium is gaseous.

According to one embodiment a valve means 31 is arranged in connection with the impeding means 30, which valve means when opened allows the conducting of flowing medium into the channel space 10 of the material conveying channel from the point of, or from the vicinity of, the impeding means 30 and when closed prevents the conducting of flowing medium into the channel space 10.

According to one embodiment the impeding means 30 is adapted to cover only a part of the flow cross-sectional area of the channel space 10 of the material conveying channel.

According to one embodiment the impeding means 30 is formed from bar parts, rod parts or profile parts.

According to one embodiment the impeding means 30 is formed to be tubular.

According to one embodiment the impeding means 30 comprises at least one aperture 300, 301 for conducting flowing medium into the channel space 10 of the material conveying channel.

According to one embodiment an aperture 300 is formed in the wall 304 of the impeding means 30, for conducting flowing medium into the channel space 10 of the material conveying channel.

According to one embodiment in the free end 303 of the impeding means 30 is an aperture 301.

According to one embodiment at least one guide means 33a, 33b, 322 is arranged in the apparatus and at least one detent surface 30a, 30b, 305 is arranged in the impeding means 30 for keeping the impeding means 30 in the desired direction.

According to one embodiment the valve means 31 is adapted to open when displacing the impeding means 30 from the first position into the second position.

According to one embodiment the valve means 31 is arranged to be a part of the impeding means 30 or of its moving device 34, 35.

According to one embodiment the valve means 31 is arranged between the impeding means 30 and its moving device 34, 35.

According to one embodiment the valve means 31 is a support member of the impeding means 30, when the impeding means 30 is in the first position. The valve means 31 rests on the edges of the aperture of the wall of the channel, keeping the impeding means firmly in place in the first position.

According to one embodiment the size of the flow aperture 33 of the flowing medium, such as of replacement air, is adapted to increase when displacing the impeding means 30 from the first position into the second position.

According to one embodiment the means for conduction flowing medium, such as replacement air, is adapted to conduct medium into the channel space 10 from the moving device 34, 35 side of the impeding means 30.

According to one embodiment the valve means 31 has a sealing surface 311, and a countersurface 331 for the sealing surface is arranged on the wall of the aperture 33 through which the impeding means is displaced into the channel space 10 and out of it.

According to one embodiment at least one aperture 300 formed in the impeding means 30, in the wall 304 of it, is arranged to open to the side of the channel space 10 that is away from the input direction of the material.

According to one embodiment the impediment is a separate impeding means 30, which can be moved between at least two positions, a first position, in which the impeding means 30 extends into the channel space 10 of the channel section, and a second position, in which the impeding means does not essentially extend into the channel space of the channel section, and through or past which impediment the replacement air flow in the channel space is adapted to travel.

The object of the invention is also a wastes conveying system, which comprises an apparatus according to any of the aforementioned characteristic features or to any of claims 1-18.

Typically the material is waste material, such as waste material arranged in bags, or recycleable material.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Apparatus for acting on material to be conveyed in a material conveying channel, which apparatus comprises an impeding means (30), which can be arranged in the material conveying channel, which impeding means (30) can be moved between at least two positions, a first position, in which the impeding means (30) extends into the channel space (10) of the material conveying channel, and a second position, in which the impeding means does not essentially extend into the channel space of the material conveying channel, wherein means (31, 33) are arranged in connection with the impeding means (30), for conducting flowing medium, such as replacement air, from outside the material conveying channel into the channel space (10) of the material conveying channel to the point of, or into the vicinity of, the impeding means (30).

2. Apparatus according to claim 1, wherein a valve means (31) is arranged in connection with the impeding means (30), which valve means when opened allows the conducting of flowing medium into the channel space (10) of the material conveying channel from the point of, or from the vicinity of, the impeding means (30) and when closed prevents the conducting of flowing medium into the channel space (10).

3. Apparatus according to claim 1, wherein the impeding means (30) is adapted to cover only a part of the flow cross-sectional area of the channel space (10) of the material conveying channel.

4. Apparatus according to claim 1, wherein the impeding means (30) is formed from bar parts, rod parts or profile parts.

5. Apparatus according to claim 1, wherein the impeding means (30) is formed to be tubular.

6. Apparatus according to claim 1, wherein the impeding means (30) comprises at least one aperture (300, 301) for conducting flowing medium into the channel space (10) of the material conveying channel.

7. Apparatus according to claim 1, wherein an aperture (300) is formed in the wall (304) of the impeding means (30), for conducting flowing medium into the channel space (10) of the material conveying channel.

8. Apparatus according to claim 1, wherein in the free end (303) of the impeding means (30) is an aperture (301).

9. Apparatus according to claim 1, wherein at least one guide means (33a, 33b, 322) is arranged in the apparatus and at least one detent surface (30a, 30b, 305) is arranged in the impeding means (30) for keeping the impeding means (30) in the desired direction.

10. Apparatus according to claim 2, wherein the valve means (31) is adapted to open when displacing the impeding means (30) from the first position into the second position.

11. Apparatus according to claim 2, wherein the valve means (31) is arranged to be a part of the impeding means (30) or of its moving device (34, 35).

12. Apparatus according to claim 2, wherein the valve means (31) is arranged between the impeding means (30) and its moving device (34, 35).

13. Apparatus according to claim 2, wherein the valve means (31) is a support member of the impeding means (30), when the impeding means (30) is in the first position.

14. Apparatus according to claim 10, wherein the size of the flow aperture (33) of the flowing medium, such as of replacement air, is adapted to increase when displacing the impeding means (30) from the first position into the second position.

15. Apparatus according to claim 2, wherein the means for conduction flowing medium, such as replacement air, is adapted to conduct medium into the channel space (10) from the moving device (34, 35) side of the impeding means (30).

16. Apparatus according to claim 2, wherein the valve means has a sealing surface (311), and a countersurface (331) for the sealing surface is arranged on the wall of the aperture (33) through which the impeding means is displaced into the channel space (10) and out of it.

17. Apparatus according to claim 6, wherein at least one aperture (300) formed in the impeding means (30), in the wall (304) of it, is arranged to open to the side of the channel space (10) that is away from the input direction of the material.

18. Wastes conveying system, which comprises an apparatus according to claim 1.

19. Apparatus according to claim 2, wherein the impeding means (30) is adapted to cover only a part of the flow cross-sectional area of the channel space (10) of the material conveying channel.

20. Apparatus according to claim 2, wherein the impeding means (30) is formed from bar parts, rod parts or profile parts.
